(19) United States
(12) Patent Application Publication
(10) Pub. No.: US 2003/0037258 A1
(43) Pub. Date: Feb. 20, 2003

(54) Information security system and method`

(76) Inventor: Izchak Koren, Tel-Aviv (IL)

Correspondence Address: William H. Dippert, Cowan, Liebowitz & Latman, P.C., 1133 Avenue of the Americas, New York, NY, 10036, US

(21) Appl. No.: 09/932,259

(22) Filed: Aug. 17, 2001

(51) Int. Cl. H04L 9/00

(52) U.S. Cl. 713/201

(57) ABSTRACT

A secured virtual communication space system for secured communications between a plurality of communication devices communicating over a network aimed at preventing malicious communication activities previously classified as unlawful. The system comprises a plurality of control devices protected from unauthorized tampering, each control device connected to a communication device. The control device is adapted to preclude any action or obligatory execute actions with one common aim to prevent any possibility of malicious activity launched from the particular communication device it is connected to. The precluded or obligatory executed actions consist of predetermined rules—collective security code common to all control devices. The system also comprises at least one of a plurality of service node adapted to communicate with each of the plurality of control devices as a third trusted party performing at least one of the following functions: each control device authentication, each control device efficiency testing, anti-virus, vulnerability patches and SVS protocols updating, new SVS Language temporary key supply, SVS routing functions.

### FIELD OF THE INVENTION

The present invention relates to information security and secured communications. More particularly it relates to method and system for information security.

### BACKGROUND OF THE INVENTION

Presently there is much concern about the state of information security and secured communications on the whole and specifically the security situation with respect to the internet. According to a CSI/FBI survey carried out recently some 85% of respondents were concerned with computer security breaches. Huge sums of money are reportedly lost everyday as a result of communication security failures and on-line fraud case numbers are about 10 times higher than off-line cases.

Currently all security solutions generally offer local protection for a local PC, local server or local network. This current scenario of information security may somewhat be analogous to a village without a police force but rather where every citizen is responsible for his own personal security. All houses are heavily guarded and locked, every trip is carried out in an armored vehicle, and every visitor has to produce a security check pass in order to be allowed in. Yet in the absence of a police patrol robbery and theft are commonplace and every time a citizen is robbed all remaining citizens nod their heads in grief and turn their backs to the unfortunate citizen—a disturbing scenario indeed. At the same time the village bandits, fully-armed, mean and malicious impose a rain of terror in the village.

The aforementioned description depicts the present information security concept in action. It is evident that this concept consists of two constituent elements:

(1) defensive (passive) way of information protection

(2) the so-called “human factor” as the main power of nowadays Infosecurity System.

The Passive Defense approach appears to be inadequate. This conclusion has numerous confirmations in the long history of security and defense practice, as it allows the offender as much time as needed to perform as many attacks as he wishes, one of which sooner or later will succeed

Besides, improvements of the Defending system and progressions usually occur after a successful attack has been launched, which discovers the system's vulnerability—dynamics which keeps the offender in always preferable ahead position.

The classic security approach, as well as common sense, demand that humans with all their weaknesses stay out of the security process.

In sheer contradiction to this, the nowadays Information Security assigns to humans a full spectrum of functional duties: they are the ideologists (Policy), the architects, the builders and the conductors of the entire security system.

There are books of instructions and manuals which are naturally widely ignored, but unfortunately it leaves big holes in a security perimeter which is designed to operate with a man in the middle.

### BRIEF DESCRIPTION OF THE INVENTION

The present invention seeks to introduce a novel approach to information security. Instead of concentrating on local machines, local servers and local gateways to networks, the present invention introduces a new concept of a virtual space secured inside and protected from outside unauthorized intrusion and penetration.

It is therefore thus provided, in accordance with a preferred embodiment of the present invention, a secured virtual communication space system for secured communications between a plurality of communication devices communicating over a network aimed at preventing malicious communication activities previously classified as unlawful, the system comprising:

a plurality of control devices protected from unauthorized tampering, each control device connected to a communication device, the control device adapted to preclude any action or obligatory execute actions with one common aim to prevent any possibility of malicious activity launched from the particular communication device it is connected to, said precluded or obligatory executed actions consisting of predetermined rules—collective security code common to all control devices; and

at least one of a plurality of service node adapted to communicate with each of the plurality of control devices as a third trusted party performing at least one of the following functions:

each control device authentication,

each control device efficiency testing,

anti-virus, vulnerability patches and SVS protocols updating,

new SVS Language temporary key supply,

SVS routing functions.

Furthermore, in accordance with another preferred embodiment of the present invention, the communication devices include personal computers, local area network gateways, or servers.

Furthermore, in accordance with another preferred embodiment of the present invention, the control device is protected by physical means such as a sealed box.

Furthermore, in accordance with another preferred embodiment of the present invention, the control device electronic scheme architecture prevents any possibility of its program altering from outside the device.

Furthermore, in accordance with another preferred embodiment of the present invention, the control device operational program can not be altered by system user or by anyone else, creating independent status of this unit.

Furthermore, in accordance with another preferred embodiment of the present invention, the control device operational program includes a set of pre-formulated behavior rules,—collective security code,—which are fulfilled automatically and independently of the system operator will, using the independent status.

Furthermore, in accordance with another preferred embodiment of the present invention, the collective security code includes a personal identification provision including smart token, biometrics or personal data reference.

Furthermore, in accordance with another preferred embodiment of the present invention, the collective security code includes management provision, whereby local management security instructions are obligatory carried out by control device, as far as they don't contradict other security code provisions.

Furthermore, in accordance with another preferred embodiment of the present invention, according to the collective security code the entire data under processing is encrypted in two crypto codes:

local data by personal code using personal control device cryptokey;

publicly circulating data by common for all participants language cryptocode using temporary cryptokey supplied to all control devices by said at least one of a plurality service nodes.

Furthermore, in accordance with another preferred embodiment of the present invention according to the collective security code all data under processing is assigned by an integrity tag to ensure the data intact.

Furthermore, in accordance with another preferred embodiment of the present invention, according to the collective security code the control device is adapted to attach a cryptocode to each outgoing communication batch for its own identification.

Furthermore, in accordance with another preferred embodiment of the present invention, according to the collective security code the control device is adapted to attach a real name tag or anonymous tag to each outgoing communication batch for user's authentication.

Furthermore, in accordance with another preferred embodiment of the present invention, according to the collective security code the control device is adapted to allow incoming information to be accessed if it is addressed to that particular control device or if it is tagged as accessible to all.

Furthermore, in accordance with another preferred embodiment of the present invention, according to the collective security code the control device is adapted to produce receipt confirmation communication on request.

Furthermore, in accordance with another preferred embodiment of the present invention, according to the collective security code the control device is adapted to control malicious code scanning on each incoming or outgoing communication message or any data under its control.

Furthermore, in accordance with another preferred embodiment of the present invention, according to the collective security code the control device is adapted to operate as an independent intermediary in negotiable relations between his user and third party, maintaining so-called “Agreement Mode” meaning to fulfill stated instructions until both parties call the Mode off.

Furthermore, in accordance with another preferred embodiment of the present invention, according to the collective security code the control device is adapted to prevent a denial-of-service attack by following communication restrictions declared by its correspondent, which affects it in particular, following communication timetable or stopping the communication attempts at all on its correspondent demand.

Furthermore, in accordance with another preferred embodiment of the present invention, there is provided a control device for providing secured communications between a communication device, to which it is connected to, and a plurality of communication devices communicating over a network aimed at preventing malicious communication activities initiated at the communication device, by obeying a list of predetermined rules, which prevent any activity that was previously classified as unlawful.

Furthermore, in accordance with another preferred embodiment of the present invention, the control device is physically protected and sealed.

Furthermore, in accordance with another preferred embodiment of the present invention, the control device includes electronic scheme architecture preventing any possibility of its program altering from outside the unit.

Furthermore, in accordance with another preferred embodiment of the present invention, the control device operational program can not be altered by system user or by anyone else, creating independent status of this unit.

Furthermore, in accordance with another preferred embodiment of the present invention, the control device operational program includes a set of pre-formulated behavior rules,—collective security code,—which are fulfilled automatically and independently of the system operator will.

Furthermore, in accordance with another preferred embodiment of the present invention, the collective security code includes personal identification provision, which is optional, however, if the user chooses this option the procedure will include smart token, biometrics and personal data reference

Furthermore, in accordance with another preferred embodiment of the present invention, the collective security code includes management provisions, whereby local management security instructions are obligatory carried out by control device, as far as they don't contradict the other security code provisions.

Furthermore, in accordance with another preferred embodiment of the present invention, according to the collective security code the entire data under processing is encrypted in two crypto codes:

local data by personal control device cryptokey;

publicly circulating data by common for all participants language cryptocode using temporary cryptokey supplied to all control devices by at least one of a plurality of service nodes.

Furthermore, in accordance with another preferred embodiment of the present invention, according to the collective security code all the data under processing is assigned by an integrity tag to ensure the data intact.

Furthermore, in accordance with another preferred embodiment of the present invention, according to the collective security code the control device is adapted to attach a cryptocode to each outgoing communication batch for its own identification.

Furthermore, in accordance with another preferred embodiment of the present invention, according to the collective security code the control device is adapted to attach a real name tag or anonymous tag to each outgoing communication batch for user's authentication.

Furthermore, in accordance with another preferred embodiment of the present invention, according to the collective security code the control device is adapted to allow incoming information to be accessed if it is addressed to that control device or if it is tagged as accessible to all.

Furthermore, in accordance with another preferred embodiment of the present invention, according to the collective security code the control device is adapted to produce receipt confirmation communication on request.

Furthermore, in accordance with another preferred embodiment of the present invention, according to the collective security code the control device is adapted to control malicious code scanning on each incoming or outgoing communication message or any data under its control.

Furthermore, in accordance with another preferred embodiment of the present invention, according to the collective security code the control device is adapted to operate as an independent intermediary in negotiable relations between its corresponding communication device and third party, in order to fulfill stated instructions until both parties call the mode off.

Furthermore, in accordance with another preferred embodiment of the present invention, according to the collective security code the control device is adapted to prevent a denial-of-service attack by following communication restrictions declared by its correspondent, which affects it in particular following communication timetable or stopping the communication attempts at all if the correspondent insists on it.

Furthermore, in accordance with another preferred embodiment of the present invention, there is provided a method for providing a secured virtual communication space system for secured communications between a plurality of communication devices communicating over a network aimed at preventing malicious communication activities previously classified as unlawful, the method comprising:

providing a plurality of control devices protected from unauthorized tampering each control device connected to a communication device, the control device adapted to prevent communication activity that was previously classified as unlawful, by obeying a list of predetermined rules, a collective security code common to all control devices; and

providing at least one of a plurality of service nodes adapted to communicate with each of the plurality of control devices, governed by a list of predetermined rules and operating under the collective security code, and

governing communications between the communication devices through the control devices barring unlawful information attacks.

Furthermore, in accordance with another preferred embodiment of the present invention, the communication devices include personal computers, local area network gateways, or servers.

Furthermore, in accordance with another preferred embodiment of the present invention, the space is accessible only by and through the control device.

Furthermore, in accordance with another preferred embodiment of the present invention, the collective security code provisions include a list of unauthorized actions, and list of actions that need to be taken in order to prevent any known information attack launch.

Furthermore, in accordance with another preferred embodiment of the present invention, the collective security code includes a personal identification provision, which is optional including smart token, biometrics or personal data reference.

Furthermore, in accordance with another preferred embodiment of the present invention, the collective security code includes management provision, whereby local management security instructions are obligatory carried out by control device, as far as they don't contradict other security code provisions.

Furthermore, in accordance with another preferred embodiment of the present invention, according to the collective security code the entire data under processing is encrypted in two crypto codes:

local data by personal code using personal control device cryptokey;

publicly circulating data by common for all participants language cryptocode using temporary cryptokey supplied to all control devices by at least one of a plurality of service nodes.

Furthermore, in accordance with another preferred embodiment of the present invention, according to the collective security code all the data under processing is assigned by an integrity tag to ensure the data intact.

Furthermore, in accordance with another preferred embodiment of the present invention, according to the collective security code the control device is adapted to attach a cryptocode to each outgoing communication batch for its own identification.

Furthermore, in accordance with another preferred embodiment of the present invention, according to the collective security code the control device is adapted to attach a real name tag or anonymous tag to each outgoing communication batch for user's authentication.

Furthermore, in accordance with another preferred embodiment of the present invention, according to the collective security code the control device is adapted to allow incoming information to be accessed if it is addressed to that control device or if it is tagged as accessible to all.

Furthermore, in accordance with another preferred embodiment of the present invention, according to the collective security code the control device is adapted to produce receipt confirmation communication on request.

Furthermore, in accordance with another preferred embodiment of the present invention, according to the collective security code the control device is adapted to control malicious code scanning on each incoming or outgoing communication message or any data under its control.

Furthermore, in accordance with another preferred embodiment of the present invention, according to the collective security code the control device is adapted to operate as an independent intermediary in negotiable relations between the corresponding communication device and a third party, fulfilling stated instructions until both parties call the mode off.

Finally, in accordance with another preferred embodiment of the present invention, according to the collective security code the control device is adapted to prevent a denial-of-service attack by following communication restrictions declared by its correspondent, which affects it in particular following communication timetable or stopping the communication attempts at all on its correspondent demand.

### BRIEF DESCRIPTION OF THE FIGURES

In order to better understand the present invention, and appreciate its practical applications, the following Figures are provided and referenced hereafter. It should be noted that the Figures are given as examples only and in no way limit the scope of the invention as defined in the appending claims. Like components are denoted by like reference numerals.

FIG. 1a depicts the prior art approach to security and FIG. 1b illustrates a general schematic view of a secured virtual space in accordance with a preferred embodiment of the present invention.

FIG. 2 illustrates a preferred embodiment of a secured virtual space system, with a service node.

FIG. 3 illustrates another preferred embodiment of a secured virtual space system in accordance with the present invention demonstrating remote access to the secured virtual space.

### DETAILED DESCRIPTION OF THE INVENTION AND FIGURES

A main aspect of the present invention is the provision of a secured virtual space (hereafter also referred to as SVS) immune to any known forms of information attack methods.

Another main aspect of the present invention is the formation of this secured virtual space so as to achieve the desired immunity. The secured space is not achieved by barricading its participants from the outside world, but by administering a secured community approach, namely monitoring every member in this community to prevent him from launching an information attack on any other member of the community.

Another main aspect of the present invention is the boundaries of SVS which are not transparent for outsiders and created by common for all SVS users encryption system.

Another main aspect of the present invention is the condition of the SVS entering only by and through the control device, which keeps the encryption key of SVS encryption system—the only way of this space operation.

Another main aspect of the present invention is the independent status of the control device, which provides a technical means for monitoring unavoidably harmless behavior of its owner within the secured virtual space.

The conduction of the two last aspects ensures the SVS members' “good” behavior, which makes all the space immune to any kind of information attack.

The basic element of a preferred embodiment of the system of the present invention is a control device, which is a hardware, programmed device (possibly programmable to allow additional features), wired to a communication machine (such as a PC, LAN (local area network) workstation, a terminal, server etc.) The control device acts as the secured virtual space guard. It has one distinct feature—a kind of Independent Status it possesses.

The independence of Control Device means that a certain part of its program cannot be altered by its user or anyone else. Precisely this part of the program is responsible for the users harmless behavior.

This feature is provided by exclusion of system manipulation from outside as well as prevention of any possibility of electronic scheme physical access, by physical means, such as a sealed box.

In addition, the electronic scheme architecture, executed by ASIC Technology which presents a second line defense, excludes any possibility of outside system manipulation.

Using this independent status feature the control device is programmed in such a way that regardless of the operator's will or efforts, it obligatorily follows a predetermined set of behavior rules (some of which are stated herein without derogating generality).

The secured virtual space is created using a public encryption code that is common to all members of the secured virtual space community. The term “community” refers to the group of all members participating in the secured virtual space and possessing a communication device, such as an independent personal computer (PC), a LAN PC, server or any similar device, and a suitable control device adapted to operate in the manner explained herein. The public encryption code of the system is common to all members of the community (hereafter referred to as the “members”).

The encryption key, which needs to be inaccessible to either the members or any outside user, is kept secured in the control device and serves for providing secured communications in the secured virtual space. Thus the independent status of the control device and the ability to communicate in the secured virtual space exclusively by using a control device makes it possible to define a certain predetermined behavioral pattern for all members, and this sets the foothold for the whole security concept implementation of the present invention.

The control device of each member monitors the communication between this member and other members, and when an unauthorized activity from a list of actions categorized in advance (by the system manufacturer) as unauthorized actions, which may harm any other member, is attempted the control device prevents this action.

The list of unauthorized actions is formulated in a so-called “collective security code”.

To the best knowledge of the inventor, currently there are about a dozen known information attack techniques, and analyzing each one of them can help determine what kind of action should be included in the action list as an unauthorized action or as an action that needs to be taken in order to prevent a particular attack launch.

The collective security code provisions is not a law provisions in the conventional sense, which can be followed or violated,—they are technical terms to be fulfilled automatically and independently of the system user will.

The summary effect at all the provisions fulfillment disables any SVS user to perform any of known attacks, i.e. makes him absolutely harmless within SV Space.

Here follow characteristics of a proposed collective security code:

1. Identification: user identification is optional. However, if the user chooses this option the procedure will include 3 steps of identification: a) smart token; b) biometrics; c) personal information reference.

2. Management: Control Device fulfils all the local security instructions concerning access control, privileges control, secure data storage and other management functions as far as they do not contradict the other Code provisions.

3. Encryption and message digest:

a). Control Device encrypts all the local information, which is defined as its personal responsibility, by its personal encryption key.

b). Control Device encrypts all outgoing information in the common for SVS cryptosystem—so-called “SVS language” by temporary SVS language key, and supplies it with an encrypted message digest.

4.“Fingerprints”—Control Device supplies all data under processing with “Fingerprints”—a cryptocode allowing for its own identification.

5. Authentication: Control Device supplies every outgoing message with either the correct sender name or the “no signature” mark,—the sender has to choose only one of these options by passing or not identification procedure.

6. Eavesdropping prevention: Control Device reads, i.e. decrypts, only information addressed to it particularly or bearing the “free access” stamp.

7. Message receipt: on request, Control Device sends out a message receipt.

8. Contact restriction: Control Device follows communication instructions (restrictions) declared by correspondent which are affecting it in particular.

9. Malicious code scanning: Control Device controls malicious code scanning of all information packages encrypted and decrypted by it.

10. “Agreement Mode”: Control Device acts as an independent technical intermediary in negotiable relations,—“Agreement Mode”,—if its user and a third party bind it to fulfil stated instructions,—it does fulfil them until both parties call the mode off.

The operation of the collective security code can be appreciated by considering the following example.

Denial-of-Service attack, and especially its Distributed Denial-of-Service version, is considered one of the hardest attacks to handle,—in fact, there exists no effective defense techniques. The usual execution of this attack is flooding a server with senseless information for the purpose of paralyzing the system. The practice shows that even the world best security-equipped systems don't have immunity against this type of attack. SVS defense handles it in a simple and effective way. In case if server overload occurs the Control Device under attack starts to control the information flow by providing to corresponding entities a certain communication time schedule with a purpose to identify the attacker. Each corresponding Control Device follows this schedule as it is programmed to do so. After identifying the attacking correspondent(s) Control Device under attack declares “you are not welcome” addressed to the attacker, which stops him from any further communication attempts.

In a preferred embodiment of the present invention the Control Device functions in two alternative modes:

I Level Control Device—computer located unit servicing particular workstation

II Level Control Device—stay alone unit with LAN service duties

The main functions of Control Device are as follows:

a. Encryption (decryption) of information under processing in two areas

network circulating information (SVS Language) with a temporary SVS key, and

local securely storaged information with the private Control Device key

b. Self-protection: the private Control Device key is built on the physical shell code. Any attempt of physical access to the Control Device electronic scheme, meaning destruction of the Shell, eliminates this code, the private key and the operating ability of the whole unit.

c. Communication between $VS users on SVS exchange protocols executed in SVS Language

d. Interference with information exchange process within the boundaries of Collective Security Code enforcement

e. Local management duties—access and privileges control and others, specified by local management.

The controlling power of the unit is ensured by encryption keys, which are in the unit's disposal only. For example: if Mr. Smith is not allowed to read File “X” the Control Device will not decrypt it for him and so on.

The present invention is hereby explained with reference to the accompanying figures. Note that the figures are provided for the purpose of demonstrating some major aspects of the present invention, and in no way limit the scope of the present invention as defined in the appending claims.

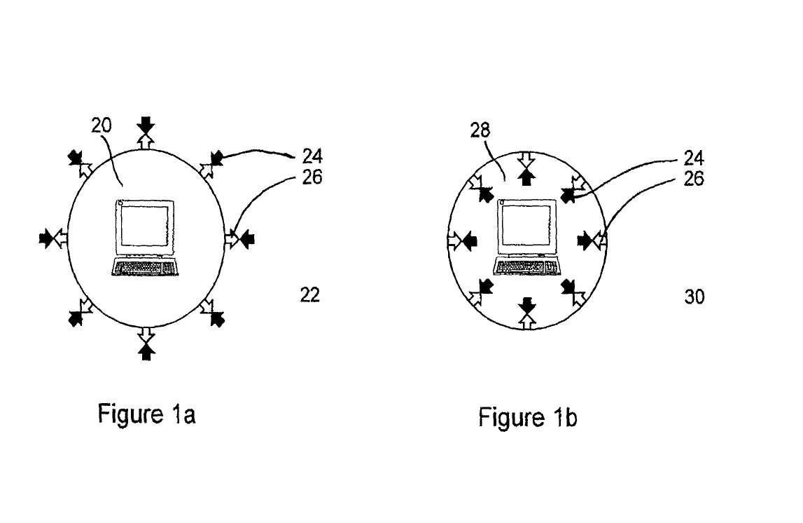

Reference is now made to FIGS. 1a and 1b, illustrating a general schematic view of a secured virtual space in accordance with a preferred embodiment of the present invention. FIG. 1a illustrates the common prior art approach to security, where a certain protected area is fenced from the unprotected area 22 of the outside world. All protection means are directed from inside out, where an information attack 24, directed from the outside unprotected area into the protected area, is met by a defense measure 26 directed outwardly to prevail the attack. In the present invention the directions are in fact reversed, as can be seen in FIG. 1b. The protected area 30 is the secured virtual space whereas the user 28, a member of the SVS community, is regarded as the threat of information attacks 24 and accordingly defense measures 26 are directed towards the user.

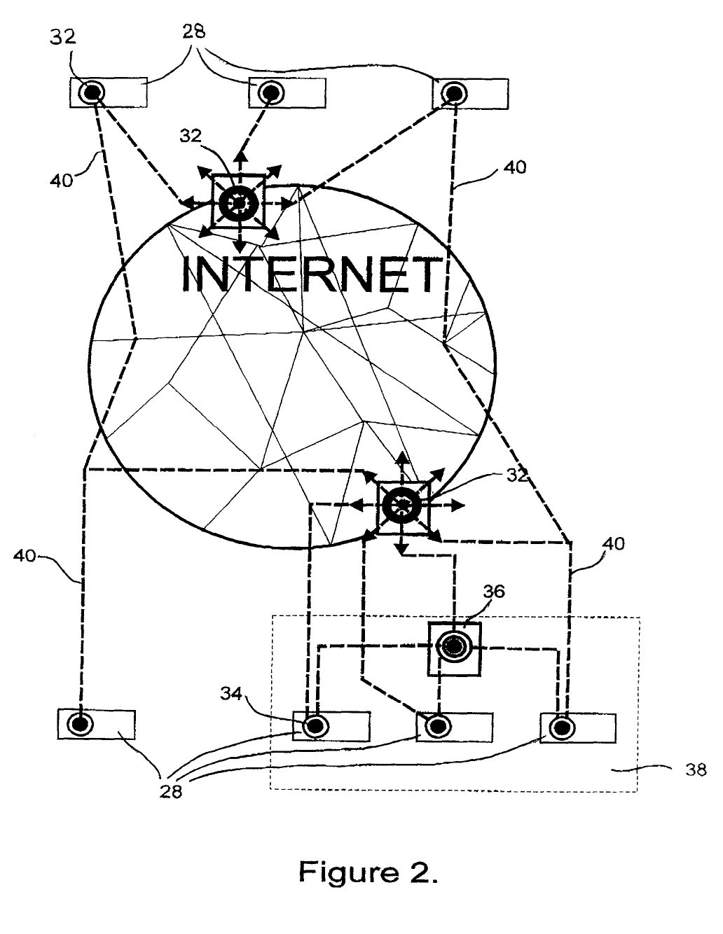

FIG. 2 illustrates the Infrastructure and information exchange within SV Space. This infrastructure includes a plurality of SVS users 28 and Web-located SVS Service Node 32. SVS Service Node presents a third trusted party and space coordinator with the following functions:

Control Device (34) authentication, using private information blocks encrypted by each Control Device private key.

Control Device efficiency testing

Security updating (anti-virus, vulnerability patches, SVS protocols)

“Agreement Mode” arbitrary function.

New “SVS Language” key supply

SV Space routing function (if required)

Basically the system uses an existing 'Net Information exchange techniques. Internet/Intranet communication is executed as follow:

The Packet Headers include Internet Protocol information and encrypted SVS Packet Headers. The communication executed in two levels:

first level—a common Internet communication procedure

second level SVS information exchange protocol.

The communication between two SVS users can be conducted directly, using their IP addresses, or if required via Service Node. In this case Service Node functions as address translator. SVS LAN communication scheme anticipates a SVS local server with powerful II level Control Device 36. within LAN (38) perimeter SVS enabled Workstations do not need services of SVS Service Node, while the local server is appointed to fulfill all the necessary procedure. At the same time each station is free to enter the Global SVS Space in the common way.

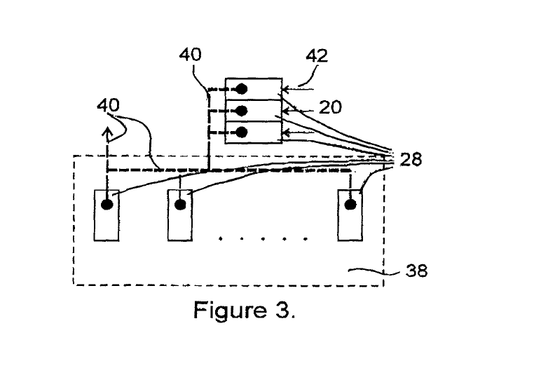

Reference is now made to FIG. 3 illustrating another preferred embodiment of a secured virtual space system in accordance with the present invention demonstrating remote access to the secured virtual space This figure depicts a remote non-secured virtual space users 20 access to a local area network 38 secured virtual space. In this case, non-members would not be identified properly, but the corporate LAN is nevertheless under protection. Such a scheme can be implemented as a service provided to non-SVS users of remote access to Secured Virtual Space.

For general assessment of this technology shell be noted that it is free of mentioned above Present Information Security shortcomings:

The Passive Defense Principle is replaced by Active Security Conception applied directly against the potential attacker.

Practically it means two things:

1. The “bad guy” has no chance to perform any of known attacks

2. In case of new attack technique invention the respond of the system is almost immidiate using the centralized SVS Node service.

Nowadays new attack handling is a long term multi faced process—from experts appreciation to wide public knowledge and gradual, time consuming defense implementation. DDoS perfectly reflects this process,—after almost two years of this attack appearance the majority of 'Net users is still vulnerable to it.

“Human factor”: the negative impact of this factor is one of the biggest problems today,—the efficiency of most advanced security tools can be reduced to zero by wrong configuration and maintenance. The automated (foolproof) way of SVS functioning guarantees reliable efficiency of conventional security tools, which are widely used in its operation.

The more detailed assessment of the technology of the present invention can be conducted by comparing its performance with practiced techniques and technologies throughout the spectrum of existing threats and information attacks.

First a private network penetration is considered. The most common defense means is a firewall, whose main function is data filtering according to predefined rules. Firewalls are usually positioned at a connection junction between the internal network and the internet, separating these two information spaces.

Despite the fact that Firewalls are widely recommended and applied, they still have a few fundamental shortcomings. A kind of tradeoff between functionality and security—i.e. tightening up filtering requirements may mean losing flexibility in applications reception and vice versa. Firewalls do not protect the network perimeter, but only networks' joint point, which requires permanent perimeter maintenance, and furthermore creates a false sense of security.

Firewalls create, in fact, easy-to-attack systems, as one hole in the network security perimeter means complete destruction of the whole first line of defense

Recent interest in wireless network technology has brought about a new problem. The wave “cloud” around these networks opens wide the door behind the companies' Firewalls.

Generally speaking, members of the secured virtual space community do not require this kind of protection at all, as there are no “bad guys” one wants to separate the network from. The secured virtual space protection principle brings up a singular, “granulated” kind of protection for each and every member, whether he belongs to a local network or not, and as such does not involve the above-listed shortcomings.

The present invention is applicable on wireless networks too. A hacker with a receiver at hand will not have an access to the secured virtual space since all information is encrypted, no matter its transmission means—be it in wire or radio wave form.

Local security hazards too are elegantly dealt with using the system and method of the present invention. By “local security hazards” it is meant attempts at the security made by an insider or by an ex-employee etc. This kind of threat is regarded by many as not so sensational nevertheless it is accounted for a great portion of overall damages (from 60 to 80% according to different sources). The security breaches considered here result from fraud, sabotage, espionage, blackmail etc. Generally there are two aspects of this kind of security hazards: the first aspect relates to wrong trust decisions made by administrators and belongs, actually, to sociology, and the second aspect relates to weak access control techniques, lack of discipline and administration and which can and ought to be handled technically.

Presently protection techniques include a wide range of identification techniques, management policy and it's monitoring Precisely this plurality of technical means accounts for, in the absence of widely accepted standards, and the existing “human factor”, the statistics mentioned above.

The present invention offers a fixed set of strong identification and automatically conducted access and privilege controls. As a result of obeying the collective security code local identification is extended and converted to strong authentication over local area networks, meaning over all the organization facilities. Above this, the overall point-to-point encryption throughout the LAN closes the security loop.

Practice shows that even “manual” employment of such measures demonstrates excellent results.

Malicious codes (i.e. destructive programs usually hidden in other programs or files with the intention of damage or control takeover) pose another hazard. Existing defense measures consist of anti-virus programs (scanning). Presently, malicious codes remain the biggest threat to information systems,—over 70% of online companies were infected with viruses in the course of 2000.

The explanation lies not only with the limited ability of anti-virus software, which deals mostly with known viruses, but to a great extent, with the way of its implementation. The key points here are package quality (comprehensive, real-time scanning) and updates.

Practice shows that those organizations and individuals who are properly using anti-virus software have this threat relatively contained and consequently regard it in a low priority.

The secured virtual space of the present invention, acting as a centralized system, is capable of supplying the best anti-virus service possible. In a preferred embodiment of the system and method of the present invention it includes quality software, automatic updates and immediate (upon discovery) alarm instructions for incident handling. An inherent feature in the present invention is the ability to trace back and identify virus sources as an effective preventing measure.

Attention is now given to attacks based on authentication breaches (masquerading, man-in-the-middle, non-repudiation, password attacks). This is a kind of attacks where the attacker pretends to be somebody else, or denies message reception or origination. Presently digital certificates or digital signatures are providing a reasonably good protection. Success of this kind of attacks is explained by mere ignoring of these techniques as it requires a certain procedure with a trusted third party involved. It is also noted that if one is already using a digital certificate one must insist on his counterpart to do the same.

The protection provided by the secured virtual space method and system of the present invention is located in the fifth provision of the collective security code. “Authentication”, as it is explained hereinabove, backed up by mutual control devices' recognition, (“Fingerprints”) handles this problem In high-level security applications the trusted party may be also issued smart tokens.

Another type of security hazards is eavesdropping (confidentiality breaches). The prime targets here are financial, corporate and personal data usually in this priority order. Existing protection measures include cryptographic data encoding. There are several cryptosystems in use. Some of them are actually unbreachable. The numerous data compromises are explained not by the strength of the Cryptosystem used but by the fact that this tool is neglected by the majority of users.

The secured virtual space system and method of the present invention provides for 100% point-to-point encryption as a precondition for entering the Space.

Yet another security hazard is the denial-of-service (DOS) attack. The aim of this attack is to paralyze a Web-server (sometimes, to penetrate the system) by forcing it to perform huge volume of useless work. It is done in different ways. File Transfer Protocol attacks and overloading or flooding the server with large volumes of small packets or large files. In a more damaging version of this hazard flooding attacks are launched from a number of computer systems—this is called “distributed Denial-of-Service” (DDoS).

Unfortunately presently there is no effective means of defense,—the techniques applied can at best merely reduce the damage impact. Firewall filtering can resist a flooding attack launched from a single IP address but it is helpless with DDoS. The only way to stop DOS is to trace back the incoming traffic to its source and shut down the transmitter, but even then the attacker can get away, as in most cases the control over the transmitting systems is hijacked by the attacker in advance.

The secured virtual space of the present invention renders a DOS attack impossible due to the implementation of the “contact restriction” provision and encrypted SVS information exchange protocols. Outside attack is possible only if the secured virtual space is penetrated. This is prevented by simple identification filtering, and needs no considerable processing resources.

Still another type of malicious attack involves exploitation of operating systems—the use of operating system flaws (vulnerabilities, bugs, or holes) to take administrative control over the system.

Existing defense includes regular updating patches of discovered vulnerabilities that is considered to be quite effective. The main problem here, as well as in similar cases, is due to administrative slips—again, the perpetual “human factor”.

The present invention deals with that problem similarly to its dealing with virus cases. Vulnerability patches are updated automatically.

Another malicious attack type consists of attacks based on machine authentication breaches (IP address spoofing, DNS exploits). These attacks are aimed at redirecting communication traffic to a bogus location or to gain unauthorized access.

Presently protection methods include point-to-point encryption, which prevents unauthorized users from reading information packets and screening policies. It is important to bear in mind with respect to this that not more than 11% of corporate users are using encryption on a regular basis. It is assumed that implementation of screening policies is more or less on the same level.

The “Fingerprints” provision of the collective security code of the present invention is most likely to eliminate this problem. An additional measure the system provides is permanent point-to-point encryption.

Yet another common security hazard is piracy—unauthorized copying and use of software. An existing effective solution here is an electronic key—a piece of hardware supplied with the program. The limitations with this kind of protection are the added costs and the popular practice of immediate online software sales. As a result, the global software industry loss is counted in billions of US dollars.

The “agreement mode” provision of the collective security code of the present invention addresses this problem in a most effective way.

There are few attacks that are hard to prevent by employing technical means, like “social engineering”, for example. But even here strict user identification can play in some cases a preventive role.

Up to now we count, in fact, all the known attacks and SVS defenses accordingly. In all the cases, an attack possibility is totally eliminated or its impact is significantly reduced.

Another major advantage of the secured virtual space system and method of the present invention is the fact that it does not rely on human intervention with all its flaws and disadvantages, making this method of security enforcement much more reliable, to compare with the existing practice.

The secured virtual space method and system of the present invention may be suitable also for non-security applications. The independent status of the control device makes it a kind of universal tool for numerous automated control functions execution.

In this sense the introduction of the secured virtual space besides enhanced security can provide control tools against spreading social menaces such as pornography, pedophilia, violence and drugs promotion, anarchism and terrorism—some experts count about 40 categories of this kind. Some 20,000 new hosts for pornography sites were being created daily and the number of sites providing illegal contents increase rapidly. The secured virtual space of the present invention can provide peaceful law obeying platform and prevent the World Wide Web from becoming World Wide Epidemic engine.

It should be clear that the description of the embodiments and attached Figures set forth in this specification serves only for a better understanding of the invention, without limiting its scope as covered by the following claims.

It should also be clear that a person skilled in the art, after reading the present specification could make adjustments or amendments to the attached Figures and above described embodiments that would still be covered by the following claims.

1. A secured virtual communication space system for secured communications between a plurality of communication devices communicating over a network aimed at preventing malicious communication activities previously classified as unlawful, the system comprising:
a plurality of control devices protected from unauthorized tampering, each control device connected to a communication device, the control device adapted to preclude any action or obligatory execute actions with one common aim to prevent any possibility of malicious activity launched from the particular communication device it is connected to, said precluded or obligatory executed actions consisting of predetermined rules—collective security code common to all control devices; and
at least one of a plurality of service node adapted to communicate with each of the plurality of control devices as a third trusted party performing at least one of the following functions:
each control device authentication,
each control device efficiency testing,
anti-virus, vulnerability patches and SVS protocols updating,
new SVS Language temporary key supply,
SVS routing functions.

2. The system of claim 1 wherein the communication devices include personal computers, local area network gateways, or servers.

3. The system of claim 1, wherein the control device is protected by physical means such as a sealed box.

4. The system of claim 1, wherein the control device electronic scheme architecture prevents any possibility of its program altering from outside the device.

5 The system of claim 1 wherein the control device operational program can not be altered by system user or by anyone else, creating independent status of this unit.

6. The system of claim 5, wherein the control device operational program includes a set of pre-formulated behavior rules,—collective security code,—which are fulfilled automatically and independently of the system operator will, using the independent status.

7. The system of claim 1, wherein the collective security code includes a personal identification provision including smart token, biometrics or personal data reference.

8. The system of claim 1, wherein the collective security code includes management provision, whereby local management security instructions are obligatory carried out by control device, as far as they don't contradict other security code provisions.

9. The system of claim 1, wherein accordingly to collective security code the entire data under processing is encrypted in two crypto codes:
local data by personal code using personal control device cryptokey;
publicly circulating data by common for all participants language cryptocode using temporary cryptokey supplied to all control devices by said at least one of a plurality service nodes.

10. The system of claim 1, wherein according to the collective security code all data under processing is assigned by an integrity tag to ensure the data intact.

11. The system of claim 1, wherein according to the collective security code the control device is adapted to attach a cryptocode to each outgoing communication batch for its own identification.

12. The system of claim 1, wherein according to the collective security code the control device is adapted to attach a real name tag or anonymous tag to each outgoing communication batch for user's authentication.

13 The system of claim 1, wherein according to the collective security code the control device is adapted to allow incoming information to be accessed if it is addressed to that particular control device or if it is tagged as accessible to all.

14. The system of claim 1, wherein according to the collective security code the control device is adapted to produce receipt confirmation communication on request.

15. The system of claim 1, wherein according to the collective security code the control device is adapted to control malicious code scanning on each incoming or outgoing communication message or any data under its control.

16. The system of claim 1, wherein according to the collective security code the control device is adapted to operate as an independent intermediary in negotiable relations between his user and third party, maintaining so-called “Agreement Mode” meaning to fulfill stated instructions until both parties call the Mode off.

17. The system of claim 1, wherein according to the collective security code the control device is adapted to prevent a denial-of-service attack by following communication restrictions declared by its correspondent, which affects it in particular, following communication timetable or stopping the communication attempts at all on its correspondent demand.

18. A control device for providing secured communications between a communication device, to which it is connected to, and a plurality of communication devices communicating over a network aimed at preventing malicious communication activities initiated at the communication device, by obeying a list of predetermined rules, which prevent any activity that was previously classified as unlawful.

19. The device of claim 18, wherein the control device is physically protected and sealed.

20. The device of claim 18, wherein the control device includes electronic scheme architecture preventing any possibility of its program altering from outside the unit.

21. The device of claim 18, wherein its operational program can not be altered by system user or by anyone else, creating independent status of this unit.

22. The device of claim 18, wherein its operational program includes a set of pre-formulated behavior rules,—collective security code,—which are fulfilled automatically and independently of the system operator will, using the independent status of claim 21.

23. The device of claim 22, wherein the collective security code includes personal identification provision, which is optional, however, if the user chooses this option the procedure will include smart token, biometrics and personal data reference.

24. The device of claim 22, wherein the collective security code includes management provisions, whereby local management security instructions are obligatory carried out by control device, as far as they don't contradict the other security code provisions.

25. The device of claim 22, wherein according to the collective security code the entire data under processing is encrypted in two crypto codes:
local data by personal control device cryptokey;
publicly circulating data by common for all participants language cryptocode using temporary cryptokey supplied to all control devices by at least one of a plurality of service nodes.

26. The device of claim 22, wherein according to the collective security code all the data under processing is assigned by an integrity tag to ensure the data intact.

27. The device of claim 22, wherein according to the collective security code the control device is adapted to attach a cryptocode to each outgoing communication batch for its own identification.

28. The device of claim 22, wherein according to the collective security code the control device is adapted to attach a real name tag or anonymous tag to each outgoing communication batch for user's authentication.

29. The device of claim 22, wherein according to the collective security code the control device is adapted to allow incoming information to be accessed if it is addressed to that control device or if it is tagged as accessible to all.

30. The device of claim 22, wherein according to the collective security code the control device is adapted to produce receipt confirmation communication on request.

31. The device of claim 22, wherein according to the collective security code the control device is adapted to control malicious code scanning on each incoming or outgoing communication message or any data under its control.

32. The device of claim 22, wherein according to the collective security code the control device is adapted to operate as an independent intermediary in negotiable relations between its corresponding communication device and third party, in order to fulfill stated instructions until both parties call the mode off.

33. The device of claim 22, wherein according to the collective security code the control device is adapted to prevent a denial-of-service attack by following communication restrictions declared by its correspondent, which affects it in particular following communication timetable or stopping the communication attempts at all if the correspondent insists on it.

34. A method for providing a secured virtual communication space system for secured communications between a plurality of communication devices communicating over a network aimed at preventing malicious communication activities previously classified as unlawful, the method comprising:
providing a plurality of control devices protected from unauthorized tampering each control device connected to a communication device, the control device adapted to prevent communication activity that was previously classified as unlawful, by obeying a list of predetermined rules, a collective security code common to all control devices; and
providing at least one of a plurality of service nodes adapted to communicate with each of the plurality of control devices, governed by a list of predetermined rules and operating under the collective security code, and
governing communications between the communication devices through the control devices barring unlawful information attacks.

35. The method of claim 34, wherein the communication devices include personal computers, local area network gateways, or servers.

36. The method of claim 34, wherein the space is accessible only by and through the control device.

37. The method of claim 34, wherein the collective security code provisions include a list of unauthorized actions, and list of actions that need to be taken in order to prevent any known information attack launch.

38. The method of claim 34, wherein the collective security code includes a personal identification provision, which is optional including smart token, biometrics or personal data reference.

39. The method of claim 34, wherein the collective security code includes management provision, whereby local management security instructions are obligatory carried out by control device, as far as they don't contradict other security code provisions.

40. The method of claim 34, wherein according to the collective security code the entire data under processing is encrypted in two crypto codes:
local data by personal code using personal control device cryptokey;
publicly circulating data by common for all participants language cryptocode using temporary cryptokey supplied to all control devices by at least one of a plurality of service nodes.

41. The method of claim 34, wherein according to the collective security code all the data under processing is assigned by an integrity tag to ensure the data intact.

42. The method of claim 34, wherein according to the collective security code the control device is adapted to attach a cryptocode to each outgoing communication batch for its own identification.

43. The method of claim 34, wherein according to the collective security code the control device is adapted to attach a real name tag or anonymous tag to each outgoing communication batch for user's authentication.

44. The method of claim 34, wherein according to the collective security code the control device is adapted to allow incoming information to be accessed if it is addressed to that control device or if it is tagged as accessible to all.

45. The method of claim 34, wherein according to the collective security code the control device is adapted to produce receipt confirmation communication on request.

46. The method of claim 34, wherein according to the collective security code the control device is adapted to control malicious code scanning on each incoming or outgoing communication message or any data under its control.

47. The method of claim 34, wherein according to the collective security code the control device is adapted to operate as an independent intermediary in negotiable relations between the corresponding communication device and a third party, fulfilling stated instructions until both parties call the mode off.

48. The method of claim 34, wherein according to the collective security code the control device is adapted to prevent a denial-of-service attack by following communication restrictions declared by its correspondent, which affects it in particular following communication timetable or stopping the communication attempts at all on its correspondent demand.
